(19) United States
(12) Patent Application Publication
(10) Pub. No.: US 2020/0187319 A1
(43) Pub. Date: Jun. 11, 2020

(54) LIGHTING APPARATUS

(71) Applicant: XIAMEN ECO LIGHTING CO. LTD., Xiamen (CN)

(72) Inventors: Hongkui Jiang, Xiamen (CN); hongbin Lin, Xiamen (CN); Biao Chen, Xiamen (CN); Zhihong Lin, Xiamen (CN)

(21) Appl. No.: 16/699,663

(22) Filed: Dec. 1, 2019

(30) Foreign Application Priority Data
Dec. 6, 2018 (CN) 201811486031.7

(51) Int. Cl. H05B 33/08; H05B 37/02; F21K 9/238

(52) U.S. Cl. CPC H05B 33/0863; F21K 9/232; F21K 9/238; H05B 37/0272

(57) ABSTRACT

A lighting apparatus includes a switch module, a current driver circuit, a current dispatching circuit and multiple light emitting modules. The light emitting module has two ends respectively connecting to the driver circuit and the current dispatching circuit for receiving either a driving current from the driver circuit or the current dispatching circuit. In different modes, the multiple light emitting modules are controlled for providing different mixed color temperatures.

### FIELD

The present invention is related to a lighting apparatus and more particularly related to a lighting apparatus with adjustable optical parameters.

### BACKGROUND

When the LED technology keeps advancing, more types of LED light devices are developed and designed. There is always a strong need to find a convenient, low cost and flexible light apparatus for improving human life.

Color temperature is an important characteristic of lighting design. Experiments are made to find that under different scenarios, people would feel comfortable for different color temperatures. Therefore, it is beneficial to design lighting devices easily to be adjusted for their color temperature.

### SUMMARY OF INVENTION

According to an embodiment, a lighting apparatus includes a switch module, a current driver circuit, a current dispatching circuit, a first light emitting module and a second light emitting module.

The switch module is provided for a user to manually select one from at least a first mode, a second mode and a third mode. There may be more modes, not necessary limited to only three modes.

The first light emitting module has a first color temperature. The second light emitting module has a second color temperature. The first color temperature is different from the second color temperature. The first light emitting module and the second light emitting module respectively have two ends connected to the current driver circuit and the current dispatching circuit respectively for receiving a driving current from either the current driver circuit or the current dispatching circuit.

For example, the first light emitting module may receive a driving current from the driving circuit in a mode while receiving a driving current from the current dispatching circuit in another mode.

Specifically, in the first mode, the first light emitting module receives the driving current from the driver circuit. In the second mode, the second light emitting module receives the driving current from the driver circuit. In the third mode, the first light emitting module and the second light emitting module both receive the driving current from the current dispatching circuit for generating a mixed color temperature by the first light emitting module and the second light emitting module.

In some embodiments, the switch module contains a mechanic switch manually moved by the user for choosing the first mode, the second mode or the third mode.

In some embodiments, the mechanic switch is electrically connected to a circuit board mounted with the driver circuit and the current dispatching circuit

In some embodiments, the driver circuit comprising a constant current source circuit.

In some embodiments, the current dispatching circuit provides a first current to the first light emitting module and a second current to the second light emitting module for mixing the mixed color temperature corresponding to a ratio between the first current and the second current.

In some embodiments, the current dispatching circuit divides an input current from the driver circuit to obtain the first current and the second current.

In some embodiments, the current dispatching circuit has a memory for storing parameters corresponding values of the first current and the second current.

In some embodiments, the current dispatching circuit comprises the current dispatching circuit comprises a receiver module, a storage module, and a control module, wherein the receiver module receives an instruction signal from the switch module, the storage module provides corresponding parameters according to the instruction signal, and the control module receives the parameters for outputting a control signal for obtaining the corresponding first current and the corresponding second current.

In some embodiments, the current dispatching circuit uses a current dispatching control unit for obtaining the first current and the second current.

In some embodiments, the lighting apparatus also includes a control circuit for receiving a control signal from an external device. The control signal is sent to the current dispatching circuit for adjusting a ratio between the driving currents for the first light emitting module and the second light emitting module for changing the mixed color temperature. For example, the external device may be a remote control, a mobile phone installed with a control app.

In some embodiments, the control circuit includes a wireless receiver for receiving a wireless signal from the external device.

In some other embodiments, the control circuit is connected via a wire to the external device, and the external device is mounted on a wall, just appearing like a conventional switch installed on a wall.

In some embodiments, the first lighting emitting module and the second light emitting module respectively have multiple units arranged alternatively to each other.

In some embodiments, the first light emitting module and the second light emitting module are light emitted diode modules.

In some embodiments, the lighting apparatus also includes a tuner for adjusting the driving current to change luminous level of the first lighting module and the second lighting module.

In some embodiments, the tuner includes a tuner circuit for adjusting a constant current source circuit to change the driving current.

In some embodiments, the lighting apparatus also includes a housing for mounting the switch module.

In some embodiments, the lighting apparatus also includes a light shell. The light shell and the housing together form a containing space for holding the first light emitting module and the second light emitting module. The housing has an Edison cap. The switch module has an operation part between the light shell and the Edison cap.

In some embodiments, the lighting apparatus also includes a third light emitting module providing a basic color temperature to be mixed with lights from the first light emitting module and the second light emitting module.

In some embodiments, the third light emitting module is controlled to generate a mixed color from multiple candidate colors.

In another aspect, a lighting apparatus is for solving the technical problems that the needed LEDs to adjust the color temperature are too many and that the operation is too complicated.

A light apparatus includes a light source board, and a switch module.

The light source board includes multiple light emitting modules. The color temperatures of the multiple light emitting modules are different. The switch module is connected to the light emitting modules and includes multiple switching positions.

In a different switching position, the switch module connects one of the light emitting modules to a circuit individually or connects at least two of the light emitting modules to circuits at the same time.

In one embodiment, the light apparatus includes a driver. The driver includes a constant current driver circuit and the current dispatching circuit that is connected to the output end of the constant current driver circuit. Each current input end of the light emitting modules diverge into two ends. One end is connected to the constant current driver circuit. The other end is connected to the current dispatching circuit. In one embodiment, the switching position includes multiple first switching positions.

The light emitting modules correspond to the first switching positions one to one. And the light emitting modules pass through the first switching position and are connected to the constant current driver circuits.

In one embodiment, between the switch module and the current dispatching circuit connects a current dispatching control unit. The current dispatching control unit controls the current that flows from the current dispatching circuit to the light emitting module.

In one embodiment, the current dispatching control unit includes a receiver module, a storage module, and a control module.

The receiver module receives the instruction signal from the switch module. The storage module gets the corresponding output signal according to the instruction signal. The control module receives the output signal and outputs a control signal to the current dispatching circuit.

In one embodiment, the current dispatching circuit includes multiple transistors.

The control end of the transistor is connected to the signal output end of the current dispatching control unit. The current input end of the transistor is connected to the output end of the constant driving current circuit. The current output end of the transistor is connected to the light emitting module.

In one embodiment, the switching position includes at least one second switching position. In the second switching position, the switch module inputs corresponding instruction signal to the receiver module.

In one embodiment, the light apparatus includes a tuner. The driver includes a tuner circuit that is connected to the tuner. The tuner circuit is connected to the constant current driver circuit and adjusts the current from the constant current driver circuit via the tuner.

In one embodiment, every light emitting module includes multiple light emitting devices. The light emitting devices of the different light emitting modules are ranged alternately. The light apparatus includes a housing. The switch module includes an operation part on the housing. The operation part is for switching the switch module from one switching position to a different switching position.

The light apparatus includes a light source board and a switch module. On the light source board includes multiple light emitting modules. And the color temperatures of the light emitting modules are different.

The switch module is connected to the multiple light emitting modules. In a different switching position, the switch module connects each light emitting module to a circuit individually or at least two light emitting modules to circuits at the same time.

There may be multiple color temperatures if each light emitting module illuminates individually. There may be other color temperatures if at least two light emitting modules are connected to the circuits at the same time, illuminate, and are mixed together.

In conventional technology, one light emitting module may present one color temperature. Compared with the conventional technology, this technology uses at least one less light emitting module, simplifies the design of the light emitting module on the light source board, and makes switching among different color temperatures easier to do.

The design is also applicable to small-volume product and meets the needs that users want to adjust the color temperature in different places.

### BRIEF DESCRIPTION OF DRAWINGS

FIG. 1 is an overall diagram of a light apparatus.

FIG. 2 is an exploded view of the light apparatus.

FIG. 3 is a cross-sectional view of the light apparatus.

FIG. 4 is a partial exploded diagram of the light apparatus.

FIG. 5 is a structure diagram of a light source board of the light apparatus.

FIG. 6 is a circuit switching diagram of the light apparatus.

FIG. 7 is a circuit diagram of a driver of the light apparatus.

FIG. 8 is a diagram of a current dispatching control unit 8 of the light apparatus.

FIG. 9 is another structural diagram of the light source board of the light apparatus.

### DETAILED DESCRIPTION

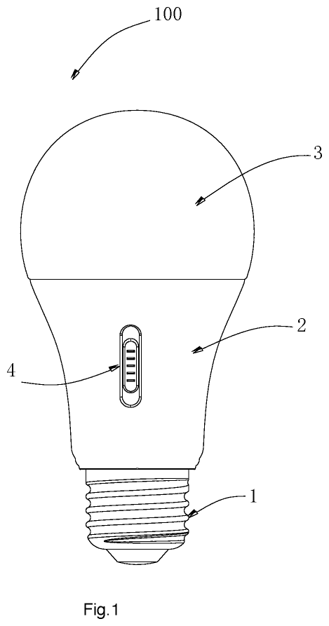

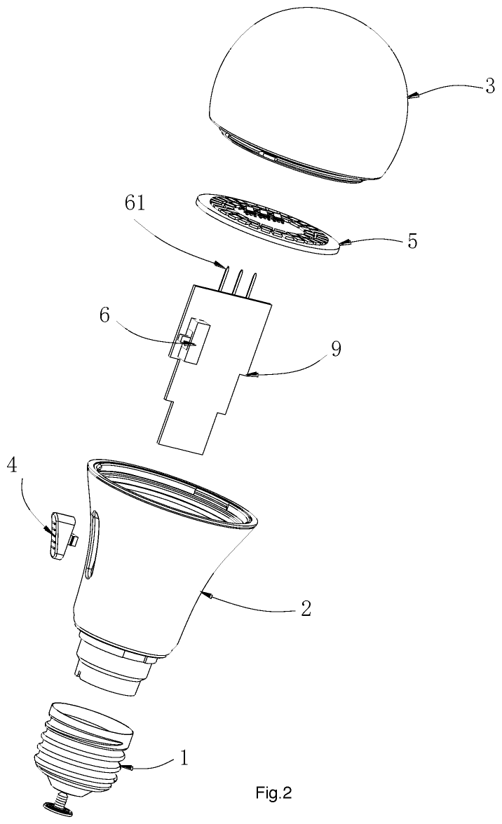

Please refer to FIG. 1 to FIG. 4. A light apparatus 100 includes a light head 1, a housing 2, and a light shell 3. The housing 2 and the light shell form a container. In the container are a driver 6 and a light source board 5. The driver 6 works on a light emitting module 50 on the light source board 5. On the housing 2, there is a switch module 4.

The switch module 4 includes multiple switching positions. On the light source board 5, there are multiple light emitting modules 50. The color temperatures of the multiple light emitting modules 50 are different.

The switch module 4 is electrically connected to the multiple light emitting modules 50.

In a different switching position, the switch module 4 connects each light emitting module 50 to a circuit individually or connects at least two light emitting modules 50 to circuits at the same time.

The color temperatures of the multiple light emitting modules 50 in the lighting apparatus are different. The switch module 4 is electrically connected to the multiple light emitting modules 50.

In a different switching position, the switch module 4 connects each light emitting module 50 to a circuit individually or connects at least two light emitting modules 50 to circuits at the same time.

Therefore, there may be multiple color temperatures when each light emitting module 50 illuminates alone or when at least two light emitting modules 50 connected to circuits at the same time illuminate. There may be other color temperatures after different light emitting modules 50 are mixed.

In conventional technology, one light emitting module may present one color temperature. Compared with the conventional technology, this technology uses at least one less light emitting module 50, simplifies the design of the light emitting module 50 on the light source board 5, and makes switching among different color temperatures easier to do.

The design is also applicable to small-volume product and meets the needs that users want to adjust the color temperature in different places.

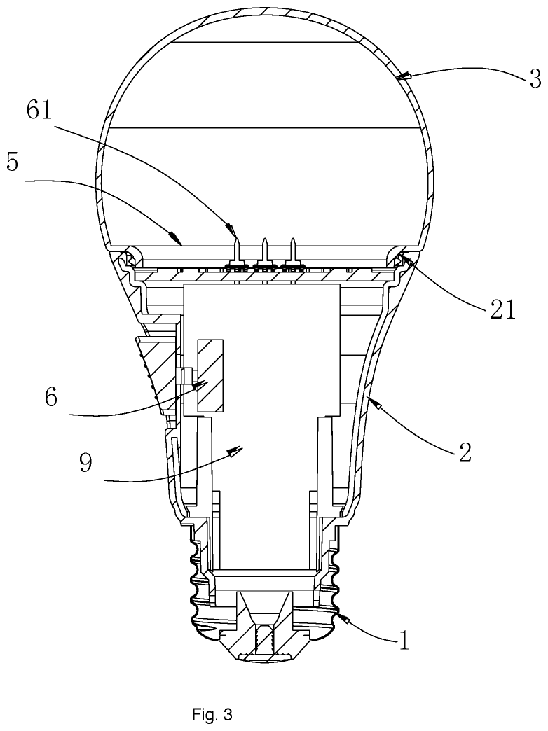

In the example of FIG. 3, the inner surface of the housing 2 includes a positioning structure 21.

The positioning structure 21 may be a ring protruding design or a protruding design of other forms. The light source board 5 is fixed to the positioning structure 21 and then to the interior of the housing 2. The driver 6 is set below the light source board 5 and electrically connected to the light source board 5.

External power source goes to the driver 6 via the light head 1. The driver 6 converts the alternating current into direct current to the light source board 5 in order to drive the light source board 5 to work.

When the light source board 5 has two light emitting modules 50, the light apparatus 100 has three color temperatures to choose from. When the light source board 5 has three light emitting modules 50, the light apparatus has seven color temperatures, which may be able to meet the needs in most situations.

First, the following is the description of the specific structure of the light apparatus 100 and how the light apparatus works in the example of two light emitting modules 50.

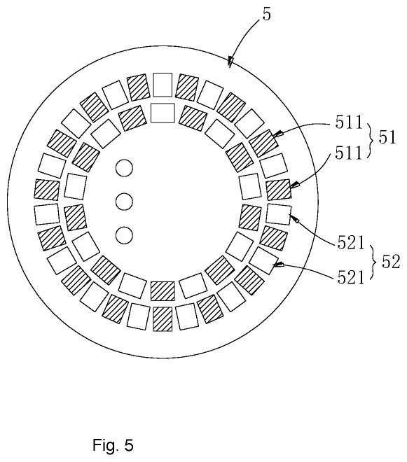

In the example of FIG. 5, the light source board is in a round shape.

The light emitting module 50 includes a first light emitting module 51 and a second light emitting module 52. The first light emitting module 51 includes multiple first light emitting devices 511 that have the first color temperature. The second light emitting module 52 includes multiple second light emitting devices that have the second color temperature.

The first light emitting device 511 and the second light emitting device are all LEDs. In one embodiment, the color temperatures of the first light emitting device 511 and the second light emitting device 521 range from 2700K to 8000K. To be specific, the color temperature may be 2700K, 3000K, 3500K, 4000K, 4500K, 5000K, 5500K, 6000K, 6500K, 7000K, or 8000K.

In practical application, the color temperatures of the first light emitting device 511 and the second light emitting device 521 may be changed based on the specific types of the light apparatus 100 and the actual situations.

For example, the first light emitting device 511 may choose the color temperature of warm white. And the color temperature ranges from 2700K to 4500K. The second light emitting device 521 may choose the color temperature of cool white. And the color temperature is above 6500K.

After the first light emitting device 511 and the second light emitting device are mixed, the color may be pure white. And the color temperature ranges from about 4500K to 6500K.

Take another example. If the first light emitting device 511 may choose the color temperature ranging from 2700K to 4500K of warm white, and if the second light emitting device 521 may choose the color temperature ranging from 4500K to 6500K of pure white, the color of the first light emitting device's 511 and the second light emitting device's 521 mixture may range from pure white to warm white.

In one embodiment, the color temperature of the first light emitting module 51 is 2700K and the color temperature of the second light emitting module 52 is 5000K.

After the first light emitting device 511 and the second light emitting device 521 are mixed, the color temperature may be 3000K.

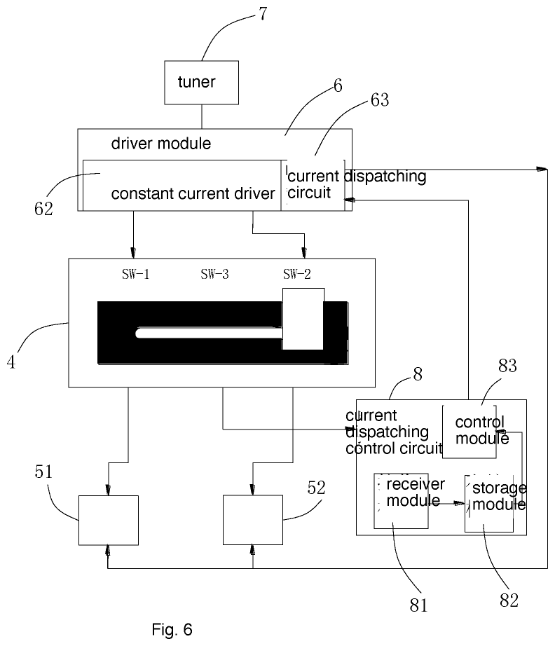

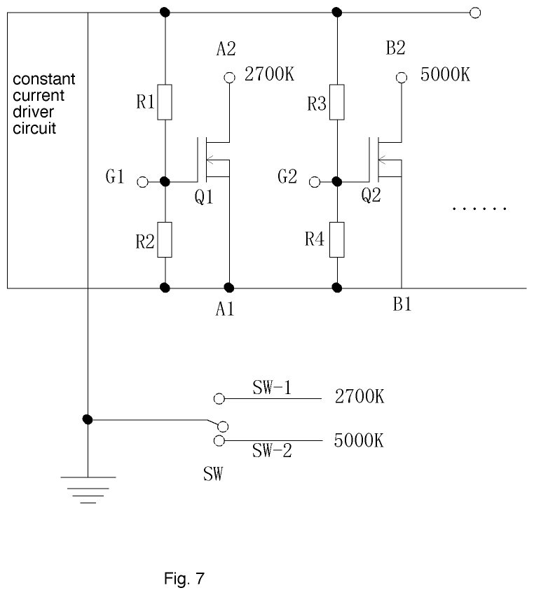

In order to make it easier to understand, in the circuit diagram description of FIG. 6 and FIG. 7 that involve the first light emitting module 51 connecting to the second light emitting module 52, “2700K” indicates the place which connects to the first light emitting module 51 and “5000K” indicates the place which connects to the second light emitting module 52.

The first light emitting devices 511 and the second light emitting devices 521 are arranged alternately to make the first light emitting devices 511 and the second light emitting devices 521 be ranged on the light source board evenly to ensure the light uniformity when the first light emitting devices 511 and the second light emitting devices 521 work individually.

In the example of FIG. 5, the first light emitting devices 511 and the second light emitting devices 521 are set in multiple circles.

In other words, every first light emitting device 511 is set between two second light emitting devices 521.

The switch module 4 is for deciding to make the two light emitting modules 50 illuminate respectively or simultaneously or to turn the two light emitting modules 50 off.

Namely, the switch module 4 is a switch of the light apparatus 100.

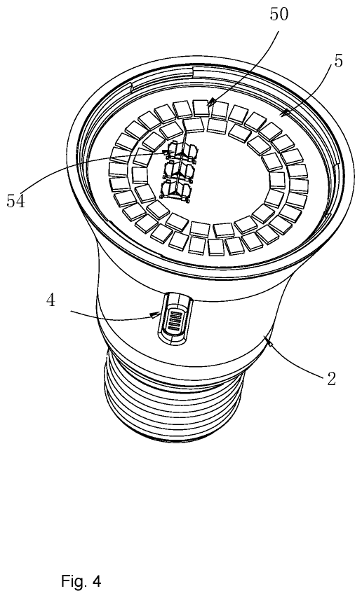

The switch module 4 may be a slide switch in the example of FIG. 1 and FIG. 4.

Or the switch module 4 may be any other forms of switch like a push-button switch or a rotary switch.

The switch module includes the operation part protruding from the housing 2, which makes it easier to operate.

Please refer to FIG. 4. The light source board 5 includes three connectors 54.

Two of the three connectors 54 are electrically connected to the first light emitting module 51 and the second light emitting module 52 respectively.

The third connector 54 is electrically connected to the first light emitting module 51 and the second light emitting connector 52 simultaneously.

The driver 6 is physically connected to three output terminals 61 via a supporting board 9.

The output terminals 61 are electrically connected to the corresponding connectors 54 one to one.

Along the direction of the current, the direct current supplied by the driver 6 arrives at the light source board 5 after passing through the switch module 4, the output terminals 61, and the connectors 54.

Then the different working circuits of the driver 6 to the first light emitting module 51 and the light emitting module 52 are completed.

Please refer to FIG. 6 and FIG. 7. The switch module 4 includes 2 first switching positions SW-1 and SW-2 and one second switching positions SW-3. Those switching positions are for indicating the color temperatures that can be switched.

When the operation part of the switch module 4 is in the first switching position, the first light emitting module 51 and the second light emitting module 52 are put in the corresponding circuits.

Then the first light emitting module 51 and the second light emitting module 52 may illuminate individually and then may present the first color temperature or the second color temperature.

When the operation part of the switch module 4 slides to the first switching position, the first light emitting module 51 and the second light emitting module 52 are put in the circuits simultaneously.

Then the first light emitting module 51 and the second light emitting module 52 may illuminate at the same time and then may present a third color temperature of the first color temperature′ and the second color temperature's mixture.

Please refer to FIG. 6. The driver includes a constant current driver circuit 62 and a current dispatching circuit 63.

The external power source is converted into constant direct current supporting the light source board 5 after constant current driver circuit's rectification, filtration, current bucking, and so on.

The current dispatching circuit 63 is connected to the output end of the constant current driver circuit 62 to distribute the direct current output by the constant current driver circuit 62 to the first light emitting module 51 and the second light emitting module 52.

To be specific, please refer to FIG. 6 and FIG. 7. The input end of the first light emitting module 51 diverges into two ends. One end passes through the first switching position SW-1 of the switch module 4 and is connected to the output end of the constant current driver circuit 62. The other end is connected to the first output end of the current dispatching circuit 63.

The input end of second light emitting module 52 diverges into two ends. One end passes through another first switching position SW-2 of the switch module 4 and is connected to the output end of the constant current driver circuit 62. The other end is connected to the first output end of the current dispatching circuit 63.

The first light emitting module 51 and the second light emitting module 52 are connected in parallel and put in the current dispatching circuit 63. On the driver 6, there is a current dispatching control unit 8.

The current dispatching control unit 8 is for controlling the current that flows from the current dispatching circuit 63 to the second light emitting module 52.

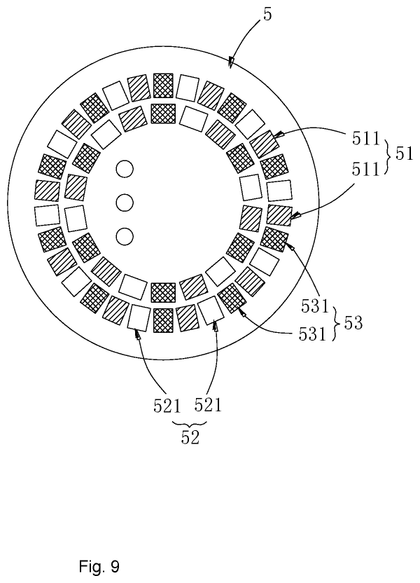

To be specific. Please refer to FIG. 9. Corresponding to the first light emitting module 51 and the second light emitting module 52, the current dispatching circuit 63 includes a first transistor Q1 and a second transistor Q2.

The control end of first transistor Q1 and the control end of the second transistor Q2 are connected to the current dispatching control units 8 respectively.

Then the current dispatching control units 8 receives the control signal.

The current input end A1 of the first transistor Q1 and the current input end B1 of the second transistor Q2 are connected to the output ends of the constant current driver circuit 62 respectively.

The current output end A2 of the first transistor Q1 and the current output end B2 of the second transistor Q2, which are also the first output end and the second output end of the current dispatching circuit 63, are connected to the first light emitting module 51 and the second light emitting module 52 respectively.

Please refer to FIG. 6. The current dispatching control unit 8 includes a receiver module 81, a storage module 82, and a control module 83.

The receiver module 81 receive the instruction signal from the switch module 4.

The storage module 82 gets the corresponding output signal according to the instruction signal.

The control module 82 receives the output signal and outputs a control signal to the current dispatching circuit 63.

In one embodiment, please refer to FIG. 6, the current dispatching control unit 8 is a Microcontroller Unit also called MCU and single chip machine.

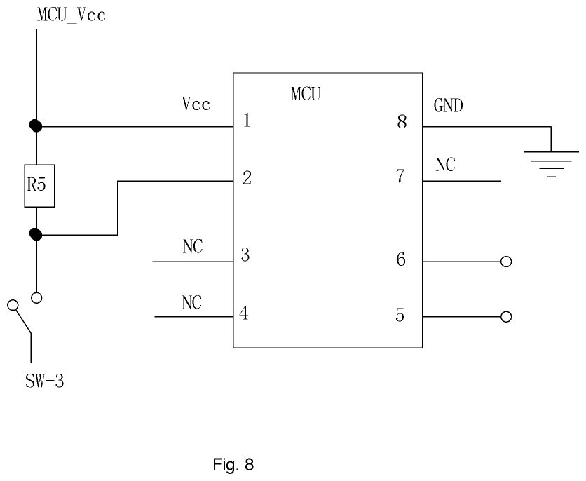

The current dispatching control unit 8 includes a control chip, a power input end Vcc connected to the control chip, an instruction input end (the pin 2 in FIG. 8), a ground end GND, and multiple control signal output ends (the pin 5 and pin 6 in FIG. 8)

The power input end Vcc is connected to the MCU Vcc to supply power to the MCU. The instruction input end passes through the resistive divider R5 and is connected to the MCU Vcc. The ground end GND is grounded.

One or more control signal output ends are connected to the control end of the first transistor. Another or more control signal output ends are connected to the control end of the second transistor.

In the example of FIG. 7, the control end G1 outputs control signal from the pin 5 to the first transistor Q1. The control end G2 outputs control signal from the pin 6 to the second transistor Q2.

Please refer to FIG. 8. When the operation part of the switch module 4 slides to the second switching position SW-3, the instruction input end of the MCU receives the current signal which is the instruction signal.

The control chip gets the definition of the instruction signal of the storage module 82 according to the instruction signal.

Then the control chip finds the corresponding output signal according to the instruction signal.

The control chip controls two or more control signal output ends, outputs the corresponding control signal to the first transistor Q1 and the second transistor Q2, and then turns on the first transistor Q1 and the second transistor Q2.

Also, the current path between the current input end A1 of the transistor Q1 and the current output end A2 of the transistor Q1 is formed.

Between the current input end B1 of the transistor Q2 and the current output end B2 of the transistor Q2 forms a current path.

The direct current flows from the constant current driver circuit 62 to the first light emitting module 51 and the second light emitting module 52.

Then the first light emitting module 51 and the second light emitting module 52 are turned on at the same time.

The constant current driver circuit 62 mentioned above may be the constant current driver circuit 62 in LED in the conventional technology.

For example, the constant current driver circuit 63 includes a breaker, a rectifier bridge, a filter module, a transformer module, a voltage protection module, a constant driver chip, and an output module for brevity.

If the user needs the light apparatus to have a color temperature which may be gained from a light emitting module, the user may put the needed light emitting module in the constant current driver circuit 62.

It is easier to drive the light apparatus. When the user needs the light apparatus to have a color temperature which may be gained by mixing two or more light emitting modules, the MCU may do it.

Please refer to FIG. 6. The light apparatus 100 includes a tuner 7, and a driver. On the driver includes a tuner circuit. The tuner 7 may be a SCR tuner 7. The tuner is connected to the tuner circuit. The tuner circuit is connected between the current dispatching circuits 63.

The tuner 7 may change the duty ratio of the flow from the first light emitting module 51 to the second light emitting module 52 and then the brightness of the first light emitting module 51 and the second light emitting module 52.

The brightness of the light apparatus may be changed on the basis that does not influence the color temperature of the light apparatus 100.

Based on the two light emitting modules 50, the following is the brief description of how the color temperatures of three light emitting modules 50 switch.

In the example of FIG. 9, on the light source board 5 includes the third light emitting module 53.

The third light emitting module 53 includes multiple third light emitting devices 531 that have the third color temperature.

The first light emitting devices 511, the second light emitting devices 521, and the third light emitting devices are ranged alternately. The color temperature of the third light emitting device 531 ranges from 2700K to 8000K. To be specific, the color temperature may be 2700K, 3000K, 3500K, 4000K, 4500K, 5000K, 5500K, 6000K, 6500K, 7000K, or 8000K.

The switch module 4 includes another first switching position electrically connected to the third light emitting module 53 and other three second switching positions.

The current input end of the third light emitting module 52 diverges into two ends. One end is connected to the output end of the constant current driver circuit 62. The other end passed through the second switching position and is connected to the third output end of the current dispatching circuit 63.

When the operation part of the switch module 4 slides to the first switching position, the third light emitting module 52 passes through the first switching position and is connected to the output end of the constant current driver circuit 62.

Then after the third light emitting module 53 is put in the corresponding circuit, there may be the color temperature that the third light emitting device decides on.

When the operation part of the switch module 4 is in the three second switching positions, the first light emitting module 51 and the third light emitting module 53 are put in the circuits at the same time, the second light emitting module 52 and the third light emitting module 53 are put it the circuits at the same time, or the first light emitting module 51, the second light emitting module 52, and the third light emitting module 53 are put in the circuits at the same time.

To be specific, the current dispatching circuit 63 also includes a third transistor.

The control end of the third transistor is connected to the current dispatching control unit 8 (take the pin 7 in FIG. 8 for example) to receive the control signal from the current dispatching control unit 8.

The current input end of the third transistor is connected to the output end of constant current driver circuit 62.

The current output end of the third transistor is connected to the third light emitting module 53.

When the switch module is in a different switching position, the current sent to the instruction input end of the MCU is different. In other words, the instruction signal is different to make the storage module 82 get different output signal.

To be specific, when the switch module 4 is in one second switching position, the instruction input end of the MCU receives a current signal.

The storage module 82 gets the output signal according to the current signal.

The MCU controls the three or more control signal output ends of the MCU outputs according to the output signal to output the corresponding control signal to the control ends of the first transistor, the second transistor, and the third transistor.

Then the first transistor, the second transistor, and the third transistor are turned on at the same time.

And then the first transistor, the second transistor, and the third transistor illuminate at the same time to get the color temperature of the first light emitting module's 51, the second light emitting module's 52, and the third light emitting module's 53 mixture.

Therefore, when the switch module 4 is in other second position, the current signal that the instruction input end of the MCU receives is different.

The MCU may choose to turn on two of the first transistor, the second transistor, and the third of the transistor.

Then two of the first transistor, the second transistor, and the third of the transistor may illuminate to get the color temperature after mixing the two of the first transistor, the second transistor, and the third of the transistor.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a switch module for a user to manually select one from at least a first mode, a second mode and a third mode;
a current driver circuit;
a current dispatching circuit;
a first light emitting module with a first color temperature; and
a second light emitting module with a second color temperature, wherein the first color temperature is different from the second color temperature, the first light emitting module and the second light emitting module respectively have two ends connected to the current driver circuit and the current dispatching circuit respectively for receiving a driving current from either the current driver circuit or the current dispatching circuit, and
wherein in the first mode, the first light emitting module receives the driving current from the driver circuit, in the second mode, the second light emitting module receives the driving current from the driver circuit and in the third mode, the first light emitting module and the second light emitting module both receive the driving current from the current dispatching circuit for generating a mixed color temperature by the first light emitting module and the second light emitting module.

2. The lighting apparatus of claim 1, wherein the switch module contains a mechanic switch manually moved by the user for choosing the first mode, the second mode or the third mode.

3. The lighting apparatus of claim 2, wherein the mechanic switch is electrically connected to a circuit board mounted with the driver circuit and the current dispatching circuit.

4. The lighting apparatus of claim 1, wherein the driver circuit comprising a constant current source circuit.

5. The lighting apparatus of claim 1, wherein the current dispatching circuit provides a first current to the first light emitting module and a second current to the second light emitting module for mixing the mixed color temperature corresponding to a ratio between the first current and the second current.

6. The lighting apparatus of claim 5, wherein the current dispatching circuit divides an input current from the driver circuit to obtain the first current and the second current.

7. The lighting apparatus of claim 6, wherein the current dispatching circuit has a memory for storing parameters corresponding values of the first current and the second current.

8. The lighting apparatus of claim 6, wherein the current dispatching circuit comprises the current dispatching circuit comprises a receiver module, a storage module, and a control module, wherein the receiver module receives an instruction signal from the switch module, the storage module provides corresponding parameters according to the instruction signal, and the control module receives the parameters for outputting a control signal for obtaining the corresponding first current and the corresponding second current.

9. The lighting apparatus of claim 5, wherein the current dispatching circuit uses a current dispatching control unit for obtaining the first current and the second current.

10. The lighting apparatus of claim 1, further comprising a control circuit for receiving a control signal from an external device, the control signal is sent to the current dispatching circuit for adjusting a ratio between the driving currents for the first light emitting module and the second light emitting module for changing the mixed color temperature.

11. The lighting apparatus of claim 10, wherein the control circuit comprises a wireless receiver for receiving a wireless signal from the external device.

12. The lighting apparatus of claim 10, wherein the control circuit is connected via a wire to the external device, and the external device is mounted on a wall.

13. The lighting apparatus of claim 1, wherein the first lighting emitting module and the second light emitting module respectively have multiple units arranged alternatively to each other.

14. The lighting apparatus of claim 1, wherein the first light emitting module and the second light emitting module are light emitted diode modules.

15. The lighting apparatus of claim 1, further comprising a tuner for adjusting the driving current to change luminous level of the first lighting module and the second lighting module.

16. The lighting apparatus of claim 15, wherein the tuner comprises a tuner circuit for adjusting a constant current source circuit to change the driving current.

17. The lighting apparatus of claim 1, further comprising a housing for mounting the switch module.

18. The lighting apparatus of claim 17, further comprising a light shell, the light shell and the housing together forming a containing space for holding the first light emitting module and the second light emitting module, and the housing having a Edison cap, the switch module having an operation part between the light shell and the Edison cap.

19. The lighting apparatus of claim 1, further comprising a third light emitting module providing a basic color temperature to be mixed with lights from the first light emitting module and the second light emitting module.

20. The lighting apparatus of claim 19, wherein the third light emitting module is controlled to generate a mixed color from multiple candidate colors.
